(19) United States
(12) Patent Application Publication
(10) Pub. No.: US 2026/0186548 A1
(43) Pub. Date: Jul. 2, 2026

(54) SYSTEM AND METHOD FOR IMPROVING POWER USING EFFICIENCY

(71) Applicant: NUVOTON TECHNOLOGY CORPORATION, HSINCHU CITY (TW)

(72) Inventor: Wei Fu LAI, zhubei City (TW)

(21) Appl. No.: 19/431,028

(22) Filed: Dec. 23, 2025

(30) Foreign Application Priority Data
Dec. 30, 2024 (TW) 113151458

(51) Int. Cl. G06F 1/3206; G06F 9/50

(52) U.S. Cl. CPC G06F 1/3206; G06F 9/505; G06F 2209/5019

(57) ABSTRACT

A system and method for improving power using efficiency are provided. The method includes periodically providing load data corresponding to load states of multiple peripheral units to a neural network unit. Based on the load data, the neural network unit calculates a power operation prediction score. An operation mode is then determined according to the prediction score to control activation and deactivation of the peripheral units. A clock rate is further adjusted according to the operation mode.

### CROSS-REFERENCE TO RELATED APPLICATION

This application claims the priority benefit of Taiwan application serial no. 113151458, filed Dec. 30, 2024, the full disclosure of which is incorporated herein by reference.

### BACKGROUND

### Technical Field

The present disclosure relates to a technology for improving power using efficiency, and more particularly to a system and method utilizing a neural network to enhance power using efficiency.

### Description of Related Art

In existing energy management systems, many solutions rely primarily on conventional switch control and fixed operation modes to achieve energy management and conservation. These systems typically control activation or deactivation of devices based on preset schedules or simple load determinations. However, such approaches cannot dynamically adjust system operation according to real-time load conditions, resulting in energy waste or reduced operational efficiency. For example, many systems continue operating all peripheral devices even when load demand is low, failing to effectively reduce unnecessary power consumption. This lack of flexibility prevents timely adjustments based on actual demand. Accordingly, such systems exhibit significant limitations in power using efficiency and are unable to maximize utilization of energy.

Furthermore, although some existing high-performance energy management systems are capable of adjusting operation modes based on load variations, they often lack intelligent prediction and adjustment mechanisms. Many systems rely only on basic sensor data to regulate load, without employing advanced data analytics or machine learning techniques, and thus cannot accurately predict future operational requirements. As a result, optimal energy efficiency cannot be achieved.

### SUMMARY

An embodiment of the present disclosure provides a system and method for improving power using efficiency. The system generates periodic load data based on operating conditions of multiple peripheral units and performs prediction and scoring through a neural network according to the load data. Accordingly, the system may control activation or deactivation of the peripheral units based on the resulting score, thereby enhancing power using efficiency.

An embodiment of the present disclosure provides a system for improving power using efficiency. The system includes a neural network unit, a plurality of peripheral units, and a system unit. The system unit is coupled to both the neural network unit and the peripheral units. It controls activation and deactivation of the peripheral units according to a power operation prediction score generated by the neural network unit. The system unit also periodically provides load data to the neural network unit based on load states of the peripheral units. The neural network unit periodically calculates the power operation prediction score from the load data. Based on this power operation prediction score, the system unit determines an operation mode. The system unit then sets a clock rate and determines which peripheral units should be activated or deactivated according to the operation mode.

In another embodiment, the present disclosure provides a method for improving power using efficiency. The method includes periodically providing load data corresponding to load states of a plurality of peripheral units to a neural network unit. The neural network unit calculates a power operation prediction score based on the load data. An operation mode is determined according to the power operation prediction score provided by the neural network unit, and the operation mode is used to control activation and deactivation of the peripheral units. A clock rate of a system unit is adjusted according to the operation mode.

In yet another embodiment, the system and method provided by the present disclosure significantly improve power using efficiency through cooperative operation between a neural network unit and the plurality of peripheral units. The system utilizes computational capabilities of the neural network unit to accurately predict power operation requirements based on load states of the peripheral units. The system dynamically adjusts activation and deactivation of the peripheral units according to prediction results, thereby avoiding unnecessary power consumption. The system also adjusts a clock rate according to actual operational demand to further optimize power usage. This method enables fine-grained load management and allows intelligent adjustment of system behavior according to the determined operation mode. As a result, the system achieves optimal power using efficiency under various operating conditions. This design enhances overall system performance, extends equipment service life, and reduces power costs, achieving both environmental and economic benefits. Through periodic load monitoring and intelligent control, the system dynamically adapts to actual requirements and effectively addresses challenges arising from different load conditions, providing a more flexible and efficient power management solution.

To further understand the technologies, approaches, and effects of the present disclosure, reference may be made to the following detailed description and accompanying drawings. Through such reference, the objectives, features, and concepts of the present disclosure may be thoroughly and concretely understood. However, the detailed description and the drawings are provided solely for purposes of illustration and explanation of embodiments of the present disclosure, and the present disclosure is not limited thereto.

### BRIEF DESCRIPTION OF THE DRAWINGS

The accompanying drawings are provided to enable persons skilled in the relevant art to further understand the present disclosure and form a part of this disclosure. The drawings illustrate exemplary embodiments of the present disclosure and, together with the description, are used to explain principles of the present disclosure.

FIG. 1 illustrates a system block diagram of a system for improving power using efficiency according to one embodiment of the present disclosure.

FIG. 2 illustrates a timing diagram of a system for improving power using efficiency according to one embodiment of the present disclosure.

FIG. 3 illustrates another system block diagram of a system for improving power using efficiency according to one embodiment of the present disclosure.

FIG. 4 illustrates a flowchart of a method for improving power using efficiency according to one embodiment of the present disclosure.

### DETAILED DESCRIPTION

Detailed reference will now be made to exemplary embodiments of the present disclosure, which are illustrated in the accompanying drawings. Where appropriate, identical reference numerals are used in the drawings and in the description to denote identical or similar components. The exemplary embodiments represent only one manner of implementing the design concepts of the present disclosure. The following examples are provided for illustration and are not intended to limit the present disclosure.

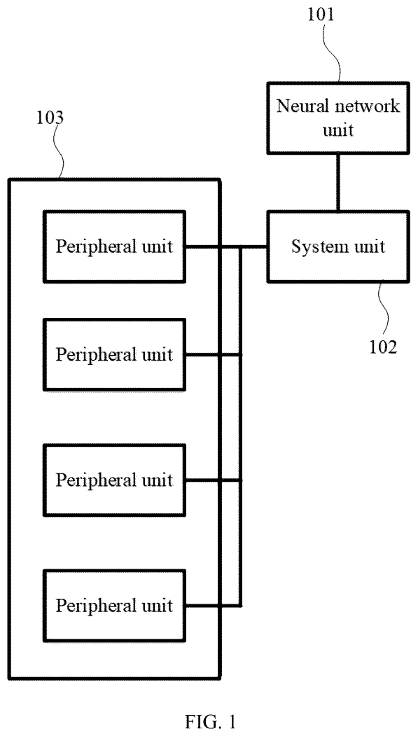

FIG. 1 illustrates a system block diagram of a system for improving power using efficiency according to one embodiment of the present disclosure. Referring to FIG. 1, the system for improving power using efficiency includes a neural network unit 101, a system unit 102, and a plurality of peripheral units 103. The system unit 102 is coupled to the neural network unit 101 and the peripheral units 103. The neural network unit 101 is incorporated into the system for improving power using efficiency. The neural network unit 101 includes a trained model. The trained model operates at intervals defined by a time period T. During each time period T, the trained model continuously receives an input matrix M_{AL} (Activity Level Matrix). The input matrix M_{AL} represents load data that is generated by integrating load levels of respective peripheral units 103 functioning as work units within the system.

In this embodiment, a load level of each peripheral unit 103 within the input matrix M_{AL} is represented in numerical form. A value of 0 indicates that the work unit is deactivated, and a maximum value indicates that the work unit is operating at full load. The neural network unit 101 uses variations in system load during each time interval as training data to establish a prediction of system load changes within the time period T. A power operation prediction score P_{sys} (Predicting Power Level) is then returned to the system unit 102 and is used as a basis for switching an energy-saving mode of the system unit 102.

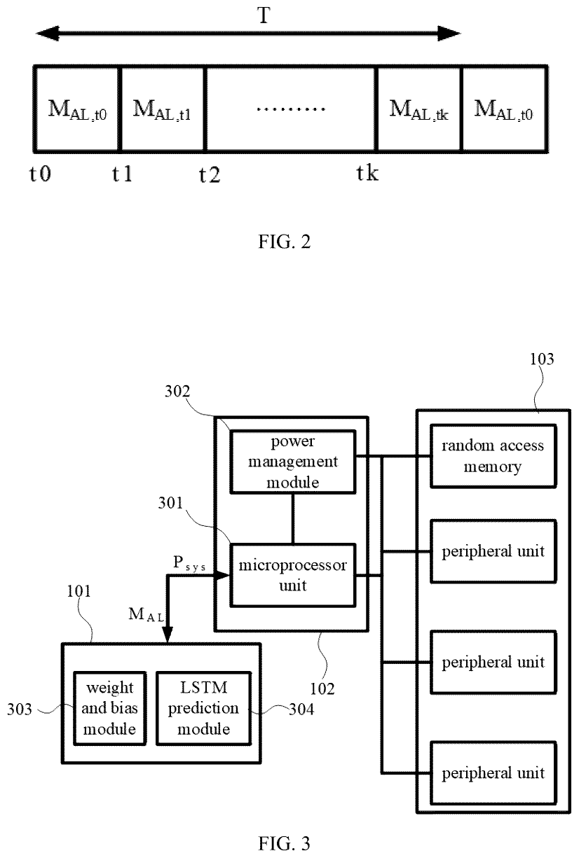

FIG. 2 illustrates a timing diagram of a system for improving power using efficiency according to one embodiment of the present disclosure. Referring to FIG. 2, the time interval T may be, for example, 30 minutes. In this embodiment, the reception intervals t0, t1, . . . , tk for the input matrix M_{AL} may be 1 minute, for example. The embodiment described above is provided for illustrating the present disclosure and is not intended to limit the present disclosure. In addition, the input matrix M_{AL} may be expressed as follows:

M_{AL}=[W₁, W₂, . . . , Wₙ]

The elements W₁, W₂, . . . , Wₙ respectively represent working load states of the peripheral units 103 within the reception intervals t0, t1, . . . , tk described above. These values are first transmitted to the system unit 102. The system unit 102 converts the values into a matrix format and transmits the matrix to the neural network unit 101. In this embodiment, the neural network unit 101 adopts a Long Short-Term Memory (LSTM) model, which is a type of recurrent neural network (RNN) suitable for processing and predicting significant events in time series with long intervals and delays. The neural network unit 101 includes a trained Long Short-Term Memory model and corresponding training parameters. In addition, in this embodiment, the peripheral units 103 may include not only general peripheral devices but also memory devices such as random-access memory.

FIG. 3 illustrates a system block diagram of a system for improving power using efficiency according to one embodiment of the present disclosure. Referring to FIG. 3, in this embodiment, the system unit 102 includes a microprocessor (MCU) unit 301 and a power management module 302. The microprocessor unit 301 is coupled to the neural network unit 101 and the peripheral units 103. The microprocessor unit 301 receives load states of the peripheral units 103, converts the load states into load data or the input matrix M_{AL}, and transmits the load data or the input matrix M_{AL} to the neural network unit 101. The microprocessor unit 301 is also used to receive the power operation prediction score P_{sys} returned by the neural network unit 101 and to determine an operating clock rate of the microprocessor unit 301. The power management module 302 is coupled to the microprocessor unit 301. The power management module 302 receives the power operation prediction score P_{sys} and determines a clock rate of the system unit 102 and activation or deactivation of the peripheral units 103 according to the power operation prediction score P_{sys}.

In this embodiment, the neural network unit 101 includes a weight-and-bias module 303 and a Long Short-Term Memory (LSTM) prediction module 304. The weight-and-bias module 303 receives the load data, namely the input matrix M_{AL}, and assigns corresponding weights and bias values based on the load data and previously stored memory data. The LSTM prediction module 304 is coupled to the weight-and-bias module 303. The LSTM prediction module 304 generates the power operation prediction score P_{sys} by performing computations using the trained model based on the load data with assigned weights and bias values and the memory data.

In this embodiment, the numerical range of the power operation prediction score P_{sys} is from 1 to 6, for example. Correspondingly, system standby states are classified into six levels as follows.

(1) A standby mode in which a low-frequency clock is selected and all memory devices and peripheral units are deactivated, wherein the term “low-frequency clock” refers to a clock frequency lower than a default frequency of a full-speed mode, which uses a frequency of a low-speed RC oscillator as a system frequency for scenarios such as, but not limited to, a watchdog timer or a chip wake-up operation from a low-power mode, and common frequencies include, but are not limited to, 10 kHz or 32 kHz.

(2) An intermediate operation mode 1 in which a low-frequency clock is selected, a portion of the memory devices is deactivated, and all peripheral units are deactivated.

(3) An intermediate operation mode 2 in which a low-frequency clock is selected, a portion of the memory devices is deactivated, and a portion of the peripheral units is deactivated.

(4) An intermediate operation mode 3 in which a low-frequency clock is selected and a portion of the memory devices is deactivated.

(5) An intermediate operation mode 4 in which a low-frequency clock is selected.

(6) The full-speed mode in which full-speed operation is performed in the default frequency.

In this embodiment, deactivating a portion of the memory devices may include, for example, deactivating several memory banks inside a memory chip or deactivating one memory rank. Since this configuration may vary depending on design requirements, the present disclosure is not limited thereto.

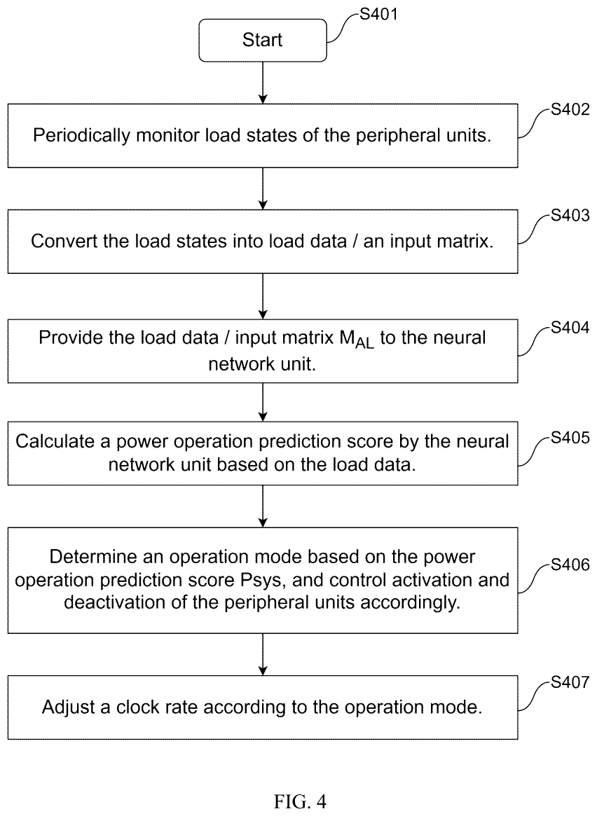

From the embodiments described above, a method for improving power using efficiency may be summarized. FIG. 4 illustrates a flowchart of a method for improving power using efficiency according to one embodiment of the present disclosure. Referring to FIG. 4, the method includes the following steps.

Step S401: Start.

Step S402: Periodically monitor load states of the peripheral units 103.

Step S403: Convert the load states into load data or the input matrix M_{AL}.

Step S404: Provide the load data or the input matrix M_{AL} to the neural network unit 101.

Step S405: Calculate the power operation prediction score P_{sys} by the neural network unit 101 based on the load data.

Step S406: Determine an operation mode according to the power operation prediction score P_{sys} provided by the neural network unit 101, and respectively control activation and deactivation of the peripheral units 103 according to the operation mode.

Step S407: Adjust a clock rate according to the operation mode. The clock rate may be, for example, a system clock rate or a processor clock rate.

In summary, the system and method provided in one embodiment of the present disclosure can significantly improve power using efficiency through cooperative operation between the neural network unit and the peripheral units. The system utilizes computational capabilities of the neural network unit to accurately predict power operation requirements according to load states of the peripheral units. The system dynamically adjusts activation and deactivation of the peripheral units based on the prediction results, thereby avoiding unnecessary power consumption. In addition, the system adjusts a clock rate according to actual operational demand to further optimize power usage. This method enables fine-grained load management and allows intelligent adjustment of operating conditions based on the selected operation mode, ensuring that optimal power using efficiency is achieved under various system conditions. The design enhances overall system performance, extends equipment service life, and reduces power costs, thereby achieving both environmental and economic benefits. Through periodic load monitoring and intelligent control, the system dynamically adapts to actual requirements and effectively addresses challenges arising from different load conditions, resulting in a more flexible and efficient power management solution.

It should be understood that the examples and embodiments described in this disclosure are provided for illustrative purposes only. Various modifications and alterations will be apparent to persons skilled in the relevant art, and such modifications and alterations are intended to be included within the spirit and scope of the present application and the scope of the appended claims.

What is claimed is:

1. A system for improving power using efficiency, comprising:
a neural network unit;
a plurality of peripheral units; and
a system unit coupled to the neural network unit and the plurality of peripheral units, being configured to control activation and deactivation of the peripheral units, and periodically provide load data to the neural network unit based on load states of the peripheral units according to a power operation prediction score provided by the neural network unit;
wherein the neural network unit periodically calculates the power operation prediction score based on the load data, such that the system unit determines an operation mode according to the power operation prediction score and determines a clock rate of the system unit and activation/deactivation of the peripheral units according to the operation mode of the system unit.

2. The system for improving power using efficiency of claim 1, wherein the system unit comprises:
a microprocessor unit, coupled to the neural network unit and the peripheral units, being configured to receive the power operation prediction score to determine an operating clock rate of the microprocessor unit, and receive the load states of the peripheral units to convert the load states into the load data and transmit the load data to the neural network unit; and
a power management module, coupled to the microprocessor unit, being configured to receive the power operation prediction score and determine the clock rate of the system unit and activation/deactivation of the peripheral units according to the power operation prediction score.

3. The system for improving power using efficiency of claim 1, wherein the neural network unit comprises:
a weight-and-bias module, being configured to receive the load data and assign weights and bias values according to the load data and memory data; and
a long short-term memory (LSTM) prediction module, coupled to the weight-and-bias module, being configured to generate the power operation prediction score based on the load data with assigned weights and bias values and the memory data.

4. The system for improving power using efficiency of claim 1, wherein the operation mode comprises:
a full-speed mode for operating at full speed in a default frequency;
a standby mode for switching a clock rate of the system unit to a low-frequency clock and disabling all peripheral units, wherein the low-frequency clock is a clock frequency lower than the default frequency of the full-speed mode, which uses a frequency of a low-speed RC oscillator as a system frequency for scenarios of a watchdog timer or a chip wake-up operation, and the system frequency is 10 kHz or 32 kHz; and
a plurality of intermediate operation modes, each disabling different peripheral units and switching the clock rate of the system unit to the low-frequency clock.

5. The system for improving power using efficiency of claim 4, wherein the number of the peripheral units is n, and the load data comprises:
M_{AL}=[W₁, W₂, . . . , Wₙ]
wherein M_{AL} represents a one-dimensional matrix of the load data, and W₁, W₂, . . . , Wn respectively represent load states of the corresponding peripheral units within a reporting period, and n, M_{AL}, and W₁ to Wₙ are natural numbers.

6. A method for improving power using efficiency, comprising:
periodically providing load data corresponding to load states of a plurality of peripheral units to a neural network unit;
calculating a power operation prediction score through the neural network unit based on the load data;
determining an operation mode based on the power operation prediction score provided by the neural network unit to control activation and deactivation of the peripheral units; and
adjusting a clock rate according to the operation mode.

7. The method of claim 6, wherein the neural network unit comprises:
a weight-and-bias module, configured to receive the load data and assign weights and bias values according to the load data and memory data; and
a long short-term memory (LSTM) prediction module, coupled to the weight-and-bias module, configured to generate the power operation prediction score based on the load data with assigned weights and bias values and the memory data.

8. The method of claim 6, wherein the operation mode comprises:
a full-speed mode for operating at full speed;
a standby mode for switching a clock rate of the system unit to a low-frequency clock and disabling all peripheral units; and
a plurality of intermediate operation modes, each disabling different peripheral units and switching the clock rate of the system unit to the low-frequency clock.

9. The method of claim 6, wherein the number of the peripheral units is n, and the load data comprises:
M_{AL}=[W₁, W₂, . . . , Wₙ]
wherein M_{AL} represents a one-dimensional matrix of the load data, and W₁, W₂, . . . , Wn respectively represent load states of the corresponding peripheral units within a reporting period, and n, M_{AL}, and W₁ to Wₙ are natural numbers.
